(19) United States
(12) Patent Application Publication
(10) Pub. No.: US 2019/0057164 A1
(43) Pub. Date: Feb. 21, 2019

(54) SEARCH METHOD AND APPARATUS BASED ON ARTIFICIAL INTELLIGENCE

(71) Applicant: BEIJING BAIDU NETCOM SCIENCE AND TECHNOLOGY CO., LTD., Beijing (CN)

(72) Inventors: Kunsheng Zhou, Beijing (CN); Shikun Feng, Beijing (CN); Zhifan Zhu, Beijing (CN); Jingzhou He, Beijing (CN)

(21) Appl. No.: 16/054,559

(22) Filed: Aug. 3, 2018

(30) Foreign Application Priority Data
Aug. 16, 2017 (CN) 201710700721.7

(51) Int. Cl. G06F 17/30; G06K 9/62; G06F 15/18

(52) U.S. Cl. CPC G06F 17/30979; G06F 17/30663; G06F 15/18; G06K 9/623; G06F 17/30967

(57) ABSTRACT

The disclosure discloses a search method and apparatus based on artificial intelligence. An embodiment of the method includes: receiving search information entered by a user; determining a candidate to-be-pushed message set based on the search information; predicting a probability of being clicked for a candidate to-be-pushed message in the candidate to-be-pushed message set using a pre-trained scoring model based on the search information and the candidate to-be-pushed message set, the scoring model being obtained by training based on a pre-stored first search information set, a to-be-pushed message set corresponding to a piece of first search information in the first search information set, and a preset priority of a to-be-pushed message in the to-be-pushed message set; and selecting a preset number of the candidate to-be-pushed messages to form a message sequence in descending order of the probability of being clicked, and pushing the message sequence to a terminal of the user.

### CROSS-REFERENCE TO RELATED APPLICATIONS

This application claims priority to Chinese Patent Application no. 201710700721.7, filed with the State Intellectual Property Office of the People's Republic of China (SIPO) on Aug. 16, 2017, the content of which is incorporated herein by reference in its entirety.

### TECHNICAL FIELD

The disclosure relates to the field of computer technology, specifically to the field of Internet technology, and more specifically to a search method and apparatus based on artificial intelligence.

### BACKGROUND

Artificial intelligence (AI) is a new technological science that studies and develops theories, methods, techniques, and applications for simulating, extending, and expanding human intelligence. Artificial intelligence is a branch of the computer science that attempts to understand the essence of intelligence and produces new intelligent machinery capable of responding in a way similar to human intelligence. Studies in the field include robots, speech recognition, image recognition, natural language processing, expert systems, and the like.

Existing search engines return ranked search results for a query, which usually provide integrated information in various aspects, such as correlation, subject authority and timeliness, but often fail to highlight information in a given aspect, such as failing to mainly highlight the subject authority, timeliness, or the like reflected in the search results. Here, the subject authority may refer to an intended subject area indicated by the search term, and a focus and a confidence level on topics in the subject area indicated by the search results.

### SUMMARY

An object of an embodiment of the disclosure is to provide an improved search method and apparatus based on artificial intelligence, to solve a part of the technical problems mentioned in the Background.

In a first aspect, an embodiment of the disclosure provides a search method based on artificial intelligence, the method including: receiving search information entered by a user; determining a candidate to-be-pushed message set based on the search information; predicting a probability of being clicked for a candidate to-be-pushed message in the candidate to-be-pushed message set using a pre-trained scoring model based on the search information and the candidate to-be-pushed message set, the scoring model being obtained by training based on a pre-stored first search information set, a to-be-pushed message set corresponding to a piece of first search information in the first search information set, and a preset priority of a to-be-pushed message in the to-be-pushed message set; and selecting a preset number of the candidate to-be-pushed messages from the candidate to-be-pushed message set to form a to-be-pushed message sequence in descending order of the probability of being clicked, and pushing the to-be-pushed message sequence to a terminal device of the user.

In some embodiments, the determining a candidate to-be-pushed message set based on the search information includes: determining whether there is target historical search information matching the search information in a pre-stored historical search information list, a piece of historical search information in the historical search information list corresponding to a to-be-pushed message set, and using the to-be-pushed message set corresponding to the target historical search information as the candidate to-be-pushed message set if the target historical search information matching the search information exists.

In some embodiments, the determining a candidate to-be-pushed message set based on the search information includes: sending the search information to a connected database server if the target historical search information does not exist, and retrieving the candidate to-be-pushed message set from the database server.

In some embodiments, the predicting a probability of being clicked for a candidate to-be-pushed message in the candidate to-be-pushed message set using a pre-trained scoring model based on the search information and the candidate to-be-pushed message set includes: extracting a keyword from the search information to generate a first keyword vector; extracting the keyword from the candidate to-be-pushed message in the candidate to-be-pushed message set to generate a second keyword vector corresponding to the candidate to-be-pushed message; and introducing, for each of the second keyword vectors, the first keyword vector and the each of the second keyword vectors into the scoring model, to obtain the probability of being clicked for the candidate to-be-pushed message corresponding to the each of the second keyword vectors.

In some embodiments, before the receiving search information entered by a user, the method further includes: executing following model training steps: obtaining, for each of the pieces of first search information in the first search information set, pairs of the to-be-pushed messages by combining in pairs the to-be-pushed messages in the to-be-pushed message set corresponding to the each of the pieces of first search information, and training a preset machine learning model based on the each of the pieces of first search information, the pairs of the to-be-pushed messages, and the priorities of the to-be-pushed messages in each of the pairs of the to-be-pushed messages, wherein the priorities of the to-be-pushed messages contained in the each of the pairs of the to-be-pushed messages are mutually different; obtaining a prediction result by executing a prediction on a test sample in a pre-stored test sample set using the trained machine learning model, the test sample in the test sample set containing second search information and a test information pair corresponding to the second search information, and pieces of test information in the test information pair have mutually different preset priorities; calculating an error rate of the prediction result based on the priorities of the pieces of test information in the test information pair contained in the test sample in the test sample set; and using the trained machine learning model as the scoring model if the error rate is lower than a threshold; and adjusting the priorities of the to-be-pushed messages in the to-be-pushed message set corresponding to the each of the pieces of first search information in the first search information set based on an error result in the prediction result if the error rate is greater than or equal to the threshold, and continuing to execute the model training steps.

In some embodiments, at least two of the to-be-pushed messages in the to-be-pushed message set corresponding to the each of the pieces of first search information in the first search information set are sourced from different websites, and for the pieces of test information in the test information pair contained in each of the test samples in the test sample set, at least two of the pieces of test information are sourced from different websites.

In some embodiments, the adjusting the priorities of the to-be-pushed messages in the to-be-pushed message set corresponding to the each of the pieces of first search information in the first search information set based on an error result in the prediction result includes: clustering the pieces of test information corresponding to the error result based on the website of the pieces of test information to obtain a plurality of test information blocks; and using the website corresponding to the test information block containing a highest number of the pieces of test information among the plurality of test information blocks as a target website, and adjusting the priorities of the to-be-pushed messages sourced from the target website in the to-be-pushed message set corresponding to the each of the pieces of first search information in the first search information set.

In some embodiments, the training a preset machine learning model based on the each of the pieces of first search information, the pairs of the to-be-pushed messages, and the priorities of the to-be-pushed messages in each of the pairs of the to-be-pushed messages includes: acquiring a first word vector corresponding to the each of the pieces of first search information and a second word vector corresponding to each of the to-be-pushed messages contained in the each of the pairs of the to-be-pushed messages respectively, wherein the second word vector is generated based on the keyword contained in the each of the to-be-pushed messages, and the first word vector is generated based on the keyword contained in the each of the pieces of first search information; and introducing, for the each of the pairs of the to-be-pushed messages, the first word vector and the second word vector corresponding to the each of the to-be-pushed messages in the each of the pairs of the to-be-pushed messages respectively into the machine learning model to obtain the probability of being clicked for the each of the to-be-pushed messages in the each of the pairs of the to-be-pushed messages, and adjusting the machine learning model based on the difference between the priority and the probability of being clicked for the each of the to-be-pushed messages in the each of the pairs of the to-be-pushed messages.

In a second aspect, an embodiment of the disclosure provides a search apparatus based on artificial intelligence, the apparatus including: a receiving unit, configured for receiving search information entered by a user; a determination unit, configured for determining a candidate to-be-pushed message set based on the search information; a prediction unit, configured for predicting a probability of being clicked for a candidate to-be-pushed message in the candidate to-be-pushed message set using a pre-trained scoring model based on the search information and the candidate to-be-pushed message set, the scoring model being obtained by training based on a pre-stored first search information set, a to-be-pushed message set corresponding to a piece of first search information in the first search information set, and a preset priority of a to-be-pushed message in the to-be-pushed message set; and a push unit, configured for selecting a preset number of the candidate to-be-pushed messages from the candidate to-be-pushed message set to form a to-be-pushed message sequence in descending order of the probability of being clicked, and pushing the to-be-pushed message sequence to a terminal device of the user.

In some embodiments, the determination unit includes: a determination subunit, configured for determining whether there is target historical search information matching the search information in a pre-stored historical search information list, a piece of historical search information in the historical search information list corresponding to a to-be-pushed message set, and using the to-be-pushed message set corresponding to the target historical search information as the candidate to-be-pushed message set if the target historical search information matching the search information exists.

In some embodiments, the determination unit includes: a sending subunit, configured for sending the search information to a connected database server if the target historical search information does not exist, and retrieving the candidate to-be-pushed message set from the database server.

In some embodiments, the prediction unit includes: a first extraction subunit, configured for extracting a keyword from the search information to generate a first keyword vector; a second extraction subunit, configured for extracting the keyword from the candidate to-be-pushed message in the candidate to-be-pushed message set to generate a second keyword vector corresponding to the candidate to-be-pushed message; and an introduction subunit, configured for introducing, for each of the second keyword vectors, the first keyword vector and the each of the second keyword vectors into the scoring model, to obtain the probability of being clicked for the candidate to-be-pushed message corresponding to the each of the second keyword vectors.

In some embodiments, the apparatus further includes: a training unit, configured for executing following model training steps: obtaining, for each of the pieces of first search information in the first search information set, pairs of the to-be-pushed messages by combining in pairs the to-be-pushed messages in the to-be-pushed message set corresponding to the each of the pieces of first search information, and training a preset machine learning model based on the each of the pieces of first search information, the pairs of the to-be-pushed messages, and the priorities of the to-be-pushed messages in each of the pairs of the to-be-pushed messages, wherein the priorities of the to-be-pushed messages contained in the each of the pairs of the to-be-pushed messages are mutually different; obtaining a prediction result by executing a prediction on a test sample in a pre-stored test sample set using the trained machine learning model, the test sample in the test sample set containing second search information and a test information pair corresponding to the second search information, and pieces of test information in the test information pair have mutually different preset priorities; calculating an error rate of the prediction result based on the priorities of the pieces of test information in the test information pair contained in the test sample in the test sample set; and using the trained machine learning model as the scoring model if the error rate is lower than a threshold; and a processing unit, configured for adjusting the priorities of the to-be-pushed messages in the to-be-pushed message set corresponding to the each of the pieces of first search information in the first search information set based on an error result in the prediction result if the error rate is greater than or equal to the threshold, and continuing to execute the model training steps.

In some embodiments, at least two of the to-be-pushed messages in the to-be-pushed message set corresponding to the each of the pieces of first search information in the first search information set are sourced from different websites, and for the pieces of test information in the test information pair contained in each of the test samples in the test sample set, at least two of the pieces of test information are sourced from different websites.

In some embodiments, the processing unit includes: a clustering subunit, configured for clustering the pieces of test information corresponding to the error result based on the website of the pieces of test information to obtain a plurality of test information blocks; and a priority adjustment subunit, configured for using the website corresponding to the test information block containing a highest number of the pieces of test information among the plurality of test information blocks as a target website, and adjusting the priorities of the to-be-pushed messages sourced from the target website in the to-be-pushed message set corresponding to the each of the pieces of first search information in the first search information set.

In some embodiments, the training unit includes: an acquisition subunit, configured for acquiring a first word vector corresponding to the each of the pieces of first search information and a second word vector corresponding to each of the to-be-pushed messages contained in the each of the pairs of the to-be-pushed messages respectively, wherein the second word vector is generated based on the keyword contained in the each of the to-be-pushed messages, and the first word vector is generated based on the keyword contained in the each of the pieces of first search information; and a training subunit, configured for introducing, for the each of the pairs of the to-be-pushed messages, the first word vector and the second word vector corresponding to the each of the to-be-pushed messages in the each of the pairs of the to-be-pushed messages respectively into the machine learning model to obtain the probability of being clicked for the each of the to-be-pushed messages in the each of the pairs of the to-be-pushed messages, and adjusting the machine learning model based on a difference between the priority and the probability of being clicked for the each of the to-be-pushed messages in the each of the pairs of the to-be-pushed messages.

In a third aspect, an embodiment of the disclosure provides an electronic device, the electronic device including: one or more processors; and a memory for storing one or more programs, where the one or more programs enable, when executed by the one or more processors, the one or more processors to implement the method according to any one of the implementations in the first aspect.

In a fourth aspect, an embodiment of the disclosure provides a computer readable storage medium storing a computer program therein, where the program implements, when executed by a processor, the method according to any one of the implementations in the first aspect.

The search method and apparatus based on artificial intelligence provided by the embodiments of the disclosure determine, after receiving search information entered by a user, a candidate to-be-pushed message set based on the search information, to facilitate predicting a probability of being clicked for a candidate to-be-pushed message in the candidate to-be-pushed message set using a pre-trained scoring model based on the search information and the candidate to-be-pushed message set. Then, the search method and apparatus select a preset number of the candidate to-be-pushed messages from the candidate to-be-pushed message set to form a to-be-pushed message sequence in descending order of the probability of being clicked, to facilitate pushing the to-be-pushed message sequence to a terminal device of the user. The scoring model obtained by training based on a pre-stored first search information set, a to-be-pushed message set corresponding to a piece of first search information in the first search information set, and a preset priority of a to-be-pushed message in the to-be-pushed message set is effectively used to predict the probability of being clicked for a candidate to-be-pushed message in the candidate to-be-pushed message set, thereby improving the validity in pushing a message.

### BRIEF DESCRIPTION OF THE DRAWINGS

By reading and referring to detailed description on the non-limiting embodiments in the following accompanying drawings, other features, objects and advantages of the disclosure will become more apparent:

FIG. 1 is a structural diagram of an illustrative system in which the disclosure may be applied;

FIG. 2 is a process diagram of an embodiment of a search method based on artificial intelligence according to the disclosure;

FIG. 3 is a schematic diagram of an application scenario of a search method based on artificial intelligence according to the disclosure;

FIG. 4 is a schematic diagram of a structure of an embodiment of a search apparatus based on artificial intelligence according to the disclosure; and

FIG. 5 is a schematic diagram of a structure of a computer system suitable for implementing an electronic device according to an embodiment of the disclosure.

### DETAILED DESCRIPTION OF EMBODIMENTS

The present application will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

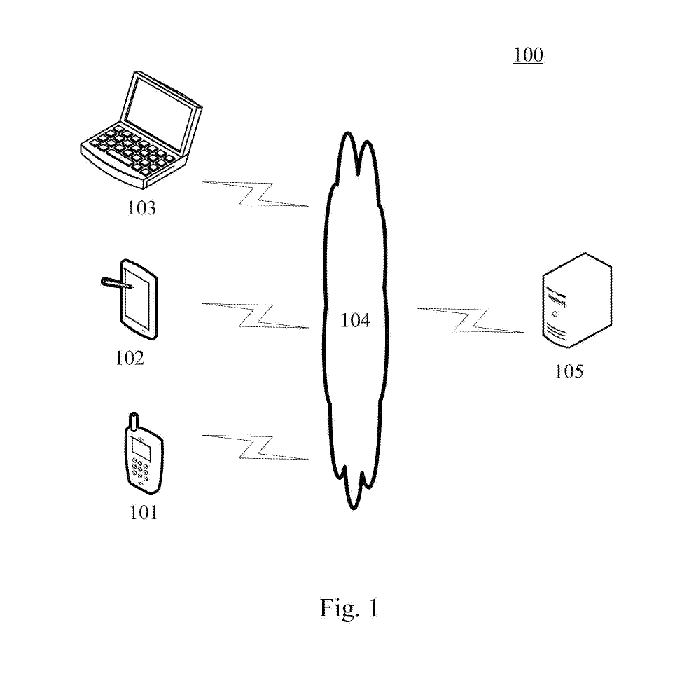

FIG. 1 shows an illustrative system architecture 100 in which an embodiment of a search method based on artificial intelligence or a search apparatus based on artificial intelligence according to the disclosure may be applied.

As shown in FIG. 1, the system architecture 100 may include terminal devices 101, 102 and 103, a network 104, and a server 105. The network 104 is used for providing a communication link medium between the terminal devices 101, 102, and 103, and the server 105. The network 104 may include a variety of connection types, such as wired or wireless transmission links, or optical fibers.

The user may interact with the server 105 using the terminal device 101, 102, or 103 through the network 104, to receive or transmit information, etc. The terminal devices 101, 102, and 103 may be installed with a variety of communication client applications, such as a webpage browser application, and an information query application.

The terminal devices 101, 102, and 103 may be a variety of electronic devices, including but not limited to smart phones, tablet computers, laptops, desktop computers, and the like.

The server 105 may be a server that provides a variety of services. For example, the server may receive search information sent by the user via the terminal device 101, 102 or 103, determine a search result (for example, a formed to-be-pushed message sequence) based on the search information, and return the search result to the terminal device.

It should be noted that the search method based on artificial intelligence provided by an embodiment of the disclosure is generally executed by the server 105. Accordingly, the search apparatus based on artificial intelligence is generally installed on the server 105.

It should be appreciated that the numbers of the terminal devices, the networks, and the servers in FIG. 1 are only illustrative. There may be any number of the terminal devices, the networks, and the servers based on the actual requirements.

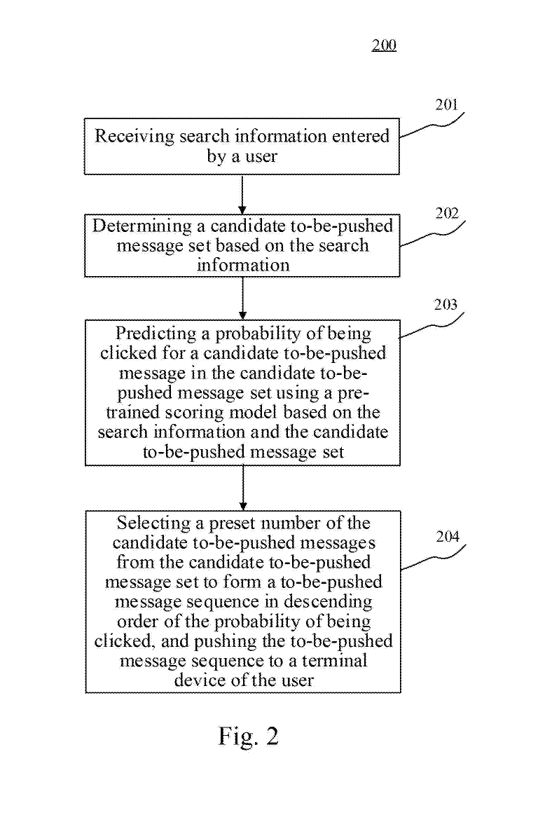

Further referring to FIG. 2, a process 200 of an embodiment of a search method based on artificial intelligence according to the disclosure is shown. The search method based on artificial intelligence includes:

Step 201: receiving search information entered by a user.

In the embodiment, an electronic device (e.g., the server 105 as shown in FIG. 1) on which the search method based on artificial intelligence runs may receive search information entered by a user from a terminal device (e.g., the terminal device 101, 102, or 103 as shown in FIG. 1) by way of wired connection or wireless connection. Here, the search information may be a search statement or a search term, which is not limited in the embodiment in any way.

Step 202: determining a candidate to-be-pushed message set based on the search information.

In the embodiment, after the electronic device receives the search information entered by the user, the electronic device can determine a candidate to-be-pushed message set based on the search information. As an example, the electronic device can directly send the search information to a connected database server, and retrieving the candidate to-be-pushed message set from the database server.

In some optional implementations of the embodiment, the electronic device may also determine the candidate to-be-pushed message set by: determining whether there is target historical search information matching the search information in a pre-stored historical search information list, a piece of historical search information in the historical search information list corresponding to a to-be-pushed message set, and using the to-be-pushed message set corresponding to the target historical search information as the candidate to-be-pushed message set if the target historical search information matching the search information exists.

As an example, the electronic device may use the historical search information identical to the search information in the historical search information list as the target historical search information. If the historical search information identical to the search information does not exist in the historical search information list, the electronic device may use the historical search information having a similarity to the search information greater than a similarity threshold in the historical search information list as the target historical search information. The electronic device can calculate the similarity between the search information and the historical search information in the historical search information list using an existing text similarity calculation method (e.g., a cosine similarity algorithm or a Jaccard coefficient method). The cosine similarity algorithm and the Jaccard coefficient method are well-known techniques, which are widely researched and applied at present, and are not repeated any more here.

In some optional implementations of the embodiment, if the electronic device determines that the target historical search information does not exist in the historical search information list, the electronic device can send the search information to the database server and retrieve the candidate to-be-pushed message set from the database server.

Step 203: predicting a probability of being clicked for a candidate to-be-pushed message in the candidate to-be-pushed message set using a pre-trained scoring model based on the search information and the candidate to-be-pushed message set.

In the embodiment, after determining the candidate to-be-pushed message set, the electronic device can predict a probability of being clicked for a candidate to-be-pushed message in the candidate to-be-pushed message set using a pre-trained scoring model based on the search information and the candidate to-be-pushed message set. Here, the scoring model may be obtained by training based on a pre-stored first search information set, a to-be-pushed message set corresponding to a piece of first search information in the first search information set, and a preset priority of a to-be-pushed message in the to-be-pushed message set.

Here, there may be a plurality of to-be-pushed messages of a given priority in the to-be-pushed message set, which is not limited in the embodiment in any way. It should be noted that the priority of each of the to-be-pushed messages in the to-be-pushed message set may be set based on multi-aspect information, such as the timeliness and the subject authority reflected in the each of the to-be-pushed messages, and the corresponding relationship between the each of the to-be-pushed messages and the corresponding piece of first search information, and mainly based on information in a given aspect of the multi-aspect information.

Furthermore, the priority of the each of the to-be-pushed messages may be expressed in the expected probability of being clicked for the each of the to-be-pushed messages, and the higher the expected probability of being clicked is, the higher the characterized priority is. It should be noted that the priority may be manually annotated (e.g., annotated by a search expert), or may be annotated by the electronic device according to a preset algorithm, which is not limited in the embodiment in any way.

As an example, the scoring model may have a characteristic extraction function, and the electronic device may introduce the search information and each of the candidate to-be-pushed messages in the candidate to-be-pushed message set into the scoring model in pairs, to enable the scoring model to extract a characteristic (e.g., a keyword) from the search information and the each of the candidate to-be-pushed messages in the candidate to-be-pushed message set, generate an eigenvector corresponding to the search information and the each of the candidate to-be-pushed messages respectively, and predict the probability of being clicked for the each of the candidate to-be-pushed messages based on the generated eigenvector. Here, the scoring model may be, e.g., a convolutional neural network model.

In some optional implementations of the embodiment, if the scoring model does not have the characteristic extraction function, the electronic device may execute: extracting a keyword from the search information to generate a first keyword vector; extracting a keyword from the candidate to-be-pushed message in the candidate to-be-pushed message set to generate a second keyword set corresponding to the candidate to-be-pushed message; and introducing, for each of the second keyword vectors, the first keyword vector and the each of the second keyword vectors into the scoring model, to obtain the probability of being clicked for the candidate to-be-pushed message corresponding to the each of the second keyword vectors.

Here, the electronic device can extract a keyword using an existing keyword extraction method (e.g., a statistical analysis method or a semantic analysis method). Taking the semantic analysis method as an example, for a candidate to-be-pushed message, the electronic device can tokenize the contents of the candidate to-be-pushed message by processing, e.g., omni-segmentation, and then calculate the importance of the obtained words (for example, using Term Frequency-Inverse Document Frequency (TF-IDF)) to obtain a keyword based on the importance calculation result.

Step 204: selecting a preset number of the candidate to-be-pushed messages from the candidate to-be-pushed message set to form a to-be-pushed message sequence in descending order of the probability of being clicked, and pushing the to-be-pushed message sequence to a terminal device of the user.

In the embodiment, after the electronic device obtains the probability of being clicked for each of the candidate to-be-pushed messages in the candidate to-be-pushed message set, the electronic device can select a preset number of the candidate to-be-pushed messages from the candidate to-be-pushed message set to form a to-be-pushed message sequence in descending order of the probability of being clicked, and push the to-be-pushed message sequence to a terminal device of the user. As an example, the electronic device can rank the candidate to-be-pushed messages in the candidate to-be-pushed message set in descending order of the probability of being clicked, and select a preset number of consecutive candidate to-be-pushed messages from the side with the highest probability of being clicked to form the to-be-pushed message sequence. It should be noted that the preset number can be adjusted based on actual requirements, which is not limited in the embodiment in any way.

In some optional implementations of the embodiment, before the electronic device receives the search information, the electronic device may further execute following model training steps, and the model training steps may, for example, include: dividing the first search information set into a training search information set and a test search information set at a preset ratio, where the number of pieces of training search information contained in the training search information set may be more than the number of pieces of test search information contained in the test search information set; training a preset machine learning model based on the training search information set, a to-be-pushed message set corresponding to each piece of training search information in the training search information set, and the priority of each of the to-be-pushed messages in the to-be-pushed message set, performing a prediction using the trained machine learning model based on the test search information set, the to-be-pushed message set corresponding to each piece of test search information in the test search information set, and the priority of each of the to-be-pushed messages in the to-be-pushed message set, and using the machine learning model as the scoring model when the prediction accuracy of the machine learning model reaches an accuracy threshold.

In some optional implementations of the embodiment, before the electronic device receives the search information, the electronic device may further execute following model training steps: obtaining, for each piece of first search information in the first search information set, pairs of the to-be-pushed messages by combining in pairs the to-be-pushed messages in the to-be-pushed message set corresponding to the each of the pieces of first search information, and training a preset machine learning model based on the each of the pieces of first search information, the pairs of the to-be-pushed messages, and the priorities of the to-be-pushed messages in each of the pairs of the to-be-pushed messages, where the priorities of the to-be-pushed messages contained in each pair of the to-be-pushed messages are mutually different; obtaining a prediction result by executing a prediction on a test sample in a pre-stored test sample set using the trained machine learning model, the test sample in the test sample set containing second search information and a test information pair corresponding to the second search information, where pieces of test information in the test information pair may have mutually different preset priorities; calculating an error rate of the prediction result based on the priorities of the pieces of test information in the test information pair contained in the test sample in the test sample set; and using the trained machine learning model as the scoring model if the error rate is lower than a threshold.

The electronic device may adjust the priorities of the to-be-pushed messages in the to-be-pushed message set corresponding to the each of the pieces of first search information in the first search information set based on an error result in the prediction result if the error rate is greater than or equal to the threshold, and continue to execute the model training steps. As an example, the electronic device may reduce the priority of a to-be-pushed message having a high priority (e.g., the highest priority or the second highest priority) in the to-be-pushed message set to reduce the priority of the to-be-pushed message. The reduced priority number may be determined randomly or based on actual requirements, which is not limited in the embodiment in any way.

Here, the prediction result on any test sample may include the probability of being clicked predicted by the machine learning model for the two pieces of test information in the test information pair contained in the test sample. If the probability of being clicked corresponding to each of the two pieces of test information is identical to a preset priority, or the absolute value of the difference between the two is lower than a difference threshold, then it may be considered that the prediction result on the test sample is a correct result; otherwise, the prediction result is an error result. Furthermore, an error rate of the prediction results obtained by executing a prediction on the test samples in the test sample set may be a ratio of the number of error results contained in the prediction results to the total number of the prediction results.

It should be noted that the priority of test information in the test information pair contained in the test sample in the test sample set may be expressed in an expected probability of being clicked of the test information, and may also be set based on multi-aspect information, such as the timeliness and the subject authority reflected in the test information, and the corresponding relationship between the test information and the corresponding second search information, and mainly based on information in a given aspect of the multi-aspect information. It should be noted that the priority of the test information may be manually annotated (e.g., annotated by a search expert), or may be annotated by the electronic device according to a preset algorithm, which is not limited in the embodiment in any way.

In some optional implementations of the embodiment, at least two of the to-be-pushed messages in the to-be-pushed message set corresponding to the piece of first search information in the first search information set may be sourced from different websites, and for the pieces of test information in the test information pair contained in each of the test samples in the test sample set, at least two of the pieces of test information may also be sourced from different websites. Here, the websites of the to-be-pushed message and the test information may be vertical websites. The vertical website, e.g., may be a website focused on a given field (for example, science and technology, entertainment, and sports).

The electronic device may cluster test information corresponding to the error result based on the website of the test information to obtain a plurality of test information blocks. Then the electronic device may use the website corresponding to the test information block containing the highest number of the pieces of test information among the plurality of test information blocks as a target website, and adjust the priorities of the to-be-pushed messages sourced from the target website in the to-be-pushed message set corresponding to the each of the pieces of first search information in the first search information set.

In some optional implementations of the embodiment, for each of the pieces of first search information in the first search information set, the electronic device may acquire a first word vector corresponding to the piece of first search information and a second word vector corresponding to each of the to-be-pushed messages contained in the each of the pairs of the to-be-pushed messages respectively. Here, the second word vector may be generated based on the keyword contained in the each of the to-be-pushed messages, and the first word vector may be generated based on the keyword contained in the each of the pieces of first search information. For the each of the pairs of the to-be-pushed messages, the electronic device may introduce the first word vector and the second word vector corresponding to the each of the to-be-pushed messages in the each of the pairs of the to-be-pushed messages respectively into the machine learning model to obtain the probability of being clicked for the each of the to-be-pushed messages in the each of the pairs of the to-be-pushed messages. The electronic device may adjust the machine learning model based on the difference between the priority and the probability of being clicked for the each of the to-be-pushed messages in the each of the pairs of the to-be-pushed messages.

As an example, the machine learning model may be adjusted by adjusting an input matrix, a hidden layer matrix, and/or an output matrix of the machine learning model. It should be noted that the first word vector and the second word vector may be pre-generated and stored in a specified storage location (e.g., locally on the electronic device, or on a server in remote communication connection with the electronic device), and the electronic device can acquire the first word vector and the second word vector from the specified storage location.

Optionally, for each of the pieces of first search information in the first search information set, if neither of the first word vector corresponding to the each of the pieces of first search information and the second word vector corresponding to the each of the to-be-pushed messages in the to-be-pushed message set corresponding to the each of the pieces of first search information is pre-generated, the electronic device may, for example, extract a keyword from the first search information and the to-be-pushed message respectively using the existing keyword extraction method, and then generate the first word vector corresponding to the each of the pieces of first search information, and the second word vector corresponding to the to-be-pushed message respectively.

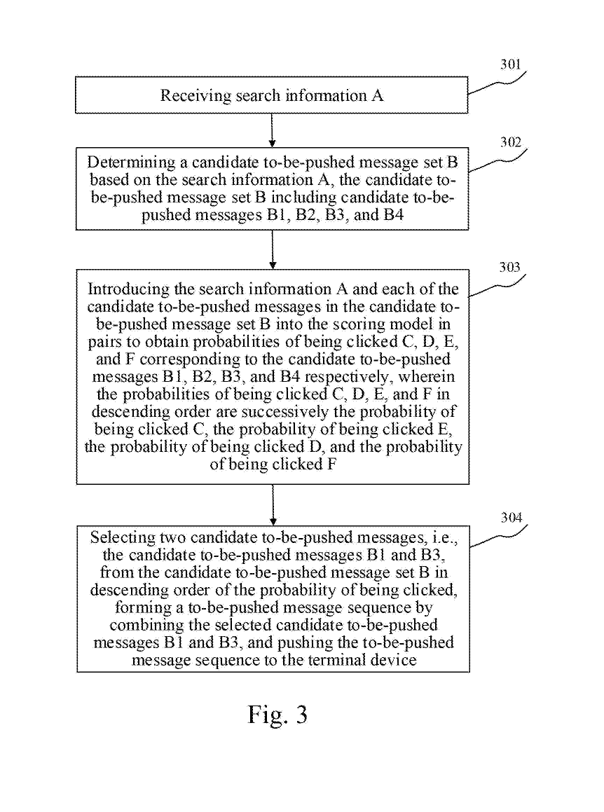

Further referring to FIG. 3, a schematic diagram of an application scenario of a search method based on artificial intelligence according to the embodiment is shown. In the application scenario of FIG. 3, the pre-trained scoring model used by the server integrates the timeliness of a to-be-pushed message, and the corresponding relationship between the to-be-pushed message and the corresponding first search information in a training process, and mainly highlights the timeliness of the to-be-pushed message. Here, the user first may enter search information A through the terminal device. Then, as shown by the reference numeral 301, the server may receive the search information A. Then, as shown by the reference numeral 302, the server may determine a candidate to-be-pushed message set B based on the search information A, wherein the candidate to-be-pushed message set B includes candidate to-be-pushed messages B1, B2, B3, and B4. Then, as shown by the reference numeral 303, the server may introduce the search information A and each of the candidate to-be-pushed messages in the candidate to-be-pushed message set B into the scoring model in pairs to obtain probabilities of being clicked C, D, E, and F corresponding to the candidate to-be-pushed messages B1, B2, B3, and B4 respectively, where the probabilities of being clicked C, D, E, and F in descending order are successively the probability of being clicked C, the probability of being clicked E, the probability of being clicked D, and the probability of being clicked F. Finally, as shown by the reference numeral 304, the server may select two candidate to-be-pushed messages, i.e., the candidate to-be-pushed messages B1 and B3, from the candidate to-be-pushed message set B in descending order of the probability of being clicked, form a to-be-pushed message sequence by combining the selected candidate to-be-pushed messages B1 and B3, and push the to-be-pushed message sequence to the terminal device.

It should be noted that the candidate to-be-pushed message B1 may be a message having high correlation (e.g., the highest or second highest correlation) with the search information A and having a latest creation time in the candidate to-be-pushed message set B. It should be noted that the application scenario is only an example, and should not limit the scope of protection of the disclosure in any way.

The method provided by the above embodiments of the disclosure effectively uses the scoring model obtained by training based on a pre-stored first search information set, a to-be-pushed message set corresponding to a piece of first search information in the first search information set, and a preset priority of a to-be-pushed message in the to-be-pushed message set to predict the probability of being clicked for each candidate to-be-pushed message in the candidate to-be-pushed message set, thereby improving the validity in pushing a message.

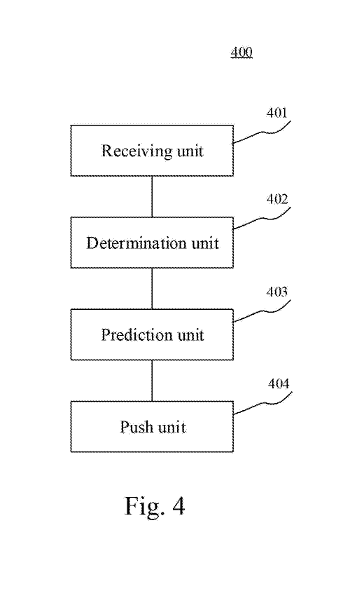

Further referring to FIG. 4, as implementations of the method shown in the above figures, the disclosure provides an embodiment of a search apparatus based on artificial intelligence. The embodiment of the apparatus corresponds to the embodiment of the method as shown in FIG. 2, and the apparatus may be specifically applied to a variety of electronic devices.

As shown in FIG. 4, a search apparatus 400 based on artificial intelligence as shown in the embodiment includes: a receiving unit 401, a determination unit 402, a prediction unit 403, and a push unit 404. The receiving unit 401 is configured for receiving search information entered by a user; the determination unit 402 is configured for determining a candidate to-be-pushed message set based on the search information; the prediction unit 403 is configured for predicting a probability of being clicked for a candidate to-be-pushed message in the candidate to-be-pushed message set using a pre-trained scoring model based on the search information and the candidate to-be-pushed message set, the scoring model being obtained by training based on a pre-stored first search information set, a to-be-pushed message set corresponding to a piece of first search information in the first search information set, and a preset priority of a to-be-pushed message in the to-be-pushed message set; and the push unit 404 is configured for selecting a preset number of the candidate to-be-pushed messages from the candidate to-be-pushed message set to form a to-be-pushed message sequence in descending order of the probability of being clicked, and pushing the to-be-pushed message sequence to a terminal device of the user.

In the embodiment, in the search apparatus 400 based on artificial intelligence: specific processing of the receiving unit 401, the determination unit 402, the prediction unit 403, and the push unit 404 and technical effects brought thereby may be respectively referred to in relevant description of the steps 201, 202, 203 and 204 in the embodiment corresponding to FIG. 2, and are not repeated any more here.

In some optional implementations of the embodiment, the determination unit 402 may include: a determination subunit (not shown in the figure), configured for determining whether there is target historical search information matching the search information in a pre-stored historical search information list, a piece of historical search information in the historical search information list corresponding to a to-be-pushed message set, and using the to-be-pushed message set corresponding to the target historical search information as the candidate to-be-pushed message set if the target historical search information matching the search information exists.

In some optional implementations of the embodiment, the determination unit 402 may include: a sending subunit (not shown in the figure), configured for sending the search information to a connected database server if the target historical search information does not exist, and retrieving the candidate to-be-pushed message set from the database server.

In some optional implementations of the embodiment, the prediction unit 403 may include: a first extraction subunit (not shown in the figure), configured for extracting a keyword from the search information to generate a first keyword vector; a second extraction subunit (not shown in the figure), configured for extracting the keyword from the candidate to-be-pushed message in the candidate to-be-pushed message set to generate a second keyword vector corresponding to the candidate to-be-pushed message; and an introduction subunit (not shown in the figure), configured for introducing, for each of the second keyword vectors, the first keyword vector and the each of the second keyword vectors into the scoring model, to obtain the probability of being clicked for the candidate to-be-pushed message corresponding to the each of the second keyword vectors.

In some optional implementations of the embodiment, the apparatus 400 may further include: a training unit (not shown in the figure), configured for executing following model training steps: obtaining, for each of the pieces of first search information in the first search information set, pairs of the to-be-pushed messages by combining in pairs the to-be-pushed messages in the to-be-pushed message set corresponding to the each of the pieces of first search information, and training a preset machine learning model based on the each of the pieces of first search information, the pairs of the to-be-pushed messages, and the priorities of the to-be-pushed messages in each of the pairs of the to-be-pushed messages, wherein the priorities of the to-be-pushed messages contained in the each of the pairs of the to-be-pushed messages are mutually different; obtaining a prediction result by executing a prediction on a test sample in a pre-stored test sample set using the trained machine learning model, the test sample in the test sample set containing second search information and a test information pair corresponding to the second search information, and pieces of test information in the test information pair have mutually different preset priorities; calculating an error rate of the prediction result based on the priorities of the pieces of test information in the test information pair contained in the test sample in the test sample set; and using the trained machine learning model as the scoring model if the error rate is lower than a threshold; and a processing unit (not shown in the figure), configured for adjusting the priorities of the to-be-pushed messages in the to-be-pushed message set corresponding to the each of the pieces of first search information in the first search information set based on an error result in the prediction result if the error rate is greater than or equal to the threshold, and continuing to execute the model training steps.

In some optional implementations of the embodiment, at least two of the to-be-pushed messages in the to-be-pushed message set corresponding to the each of the pieces of first search information in the first search information set are sourced from different websites, and for the pieces of test information in the test information pair contained in each of the test samples in the test sample set, at least two of the pieces of test information are sourced from different websites.

In some optional implementations of the embodiment, the processing unit may include: a clustering subunit (not shown in the figure), configured for clustering the pieces of test information corresponding to the error result based on the website of the pieces of test information to obtain a plurality of test information blocks; and a priority adjustment subunit (not shown in the figure), configured for using the website corresponding to the test information block containing a highest number of the pieces of test information among the plurality of test information blocks as a target website, and adjusting the priorities of the to-be-pushed messages sourced from the target website in the to-be-pushed message set corresponding to the each of the pieces of first search information in the first search information set.

In some optional implementations of the embodiment, the training unit may include: an acquisition subunit (not shown in the figure), configured for acquiring a first word vector corresponding to the each of the pieces of first search information and a second word vector corresponding to each of the to-be-pushed messages contained in the each of the pairs of the to-be-pushed messages respectively, wherein the second word vector is generated based on the keyword contained in the each of the to-be-pushed messages, and the first word vector is generated based on the keyword contained in the each of the pieces of first search information; and a training subunit (not shown in the figure), configured for introducing, for the each of the pairs of the to-be-pushed messages, the first word vector and the second word vector corresponding to the each of the to-be-pushed messages in the each of the pairs of the to-be-pushed messages respectively into the machine learning model to obtain the probability of being clicked for the each of the to-be-pushed messages in the each of the pairs of the to-be-pushed messages, and adjusting the machine learning model based on the difference between the priority and the probability of being clicked for the each of the to-be-pushed messages in the each of the pairs of the to-be-pushed messages.

The apparatus provided by the above embodiments of the disclosure effectively uses the scoring model obtained by training based on a pre-stored first search information set, a to-be-pushed message set corresponding to a piece of first search information in the first search information set, and a preset priority of a to-be-pushed message in the to-be-pushed message set to predict the probability of being clicked for each candidate to-be-pushed message in the candidate to-be-pushed message set, thereby improving the validity in pushing a message.

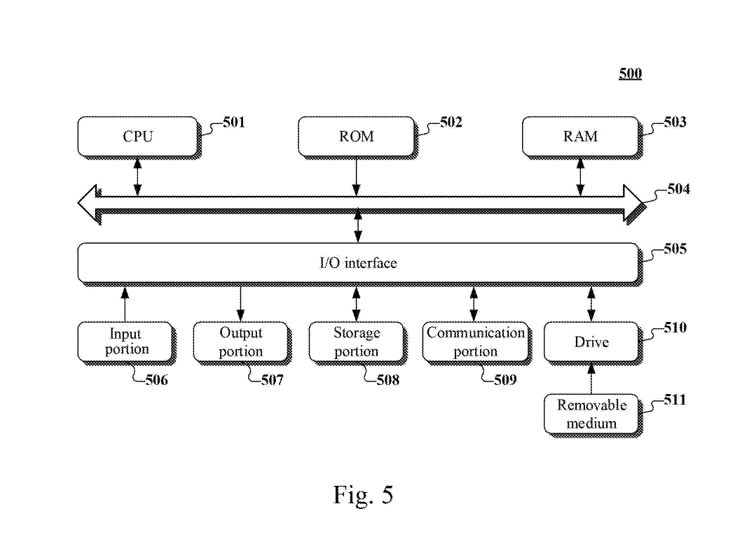

Referring to FIG. 5, a schematic structural diagram of a computer system 500 adapted to implement an electronic device of the embodiments of the present application is shown. The electronic device shown in FIG.

5 is merely an example and should not impose any restriction on the function and scope of use of the embodiments of the present application.

As shown in FIG. 5, the computer system 500 includes a central processing unit (CPU) 501, which may execute various appropriate actions and processes in accordance with a program stored in a read-only memory (ROM) 502 or a program loaded into a random access memory (RAM) 503 from a storage portion 508. The RAM 503 also stores various programs and data required by operations of the system 500. The CPU 501, the ROM 502 and the RAM 503 are connected to each other through a bus 504. An input/output (I/O) interface 505 is also connected to the bus 504.

The following components are connected to the I/O interface 505: an input portion 506 including a keyboard, a mouse etc.; an output portion 507 comprising a cathode ray tube (CRT), a liquid crystal display device (LCD), a speaker etc.; a storage portion 508 including a hard disk and the like; and a communication portion 509 comprising a network interface card, such as a LAN card and a modem. The communication portion 509 performs communication processes via a network, such as the Internet. A drive 510 is also connected to the I/O interface 505 as required. A removable medium 511, such as a magnetic disk, an optical disk, a magneto-optical disk, and a semiconductor memory, may be installed on the drive 510, to facilitate the retrieval of a computer program from the removable medium 511, and the installation thereof on the storage portion 508 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 509, and/or may be installed from the removable media 511. The computer program, when executed by the central processing unit (CPU) 501, implements the above mentioned functionalities as defined by the methods of the present disclosure.

It should be noted that the computer readable medium in the present disclosure may be computer readable storage medium. An example of the computer readable storage medium may include, but not limited to: semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. The computer readable medium may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units or modules involved in the embodiments of the present application may be implemented by means of software or hardware. The described units or modules may also be provided in a processor, for example, described as: a processor, comprising a receiving unit, a determination unit, a prediction unit, and a push unit, where the names of these units or modules do not in some cases constitute a limitation to such units or modules themselves. For example, the receiving unit may also be described as “a unit for receiving search information entered by a user.”

In another aspect, the present application further provides a non-transitory computer-readable storage medium. The non-transitory computer-readable storage medium may be the non-transitory computer-readable storage medium included in the apparatus in the above described embodiments, or a stand-alone non-transitory computer-readable storage medium not assembled into the apparatus. The non-transitory computer-readable storage medium stores one or more programs. The one or more programs, when executed by a device, cause the device to: receive search information entered by a user;

determine a candidate to-be-pushed message set based on the search information; predict a probability of being clicked for a candidate to-be-pushed message in the candidate to-be-pushed message set using a pre-trained scoring model based on the search information and the candidate to-be-pushed message set, the scoring model being obtained by training based on a pre-stored first search information set, a to-be-pushed message set corresponding to a piece of first search information in the first search information set, and a preset priority of a to-be-pushed message in the to-be-pushed message set; and select a preset number of the candidate to-be-pushed messages from the candidate to-be-pushed message set to form a to-be-pushed message sequence in descending order of the probability of being clicked, and push the to-be-pushed message sequence to a terminal device of the user.

The above description only provides an explanation of the preferred embodiments of the present application and the technical principles used. It should be appreciated by those skilled in the art that the inventive scope of the present application is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present application are examples.

What is claimed is:

1. A search method based on artificial intelligence, comprising:
receiving search information entered by a user;
determining a candidate to-be-pushed message set based on the search information;
predicting a probability of being clicked for a candidate to-be-pushed message in the candidate to-be-pushed message set using a pre-trained scoring model based on the search information and the candidate to-be-pushed message set, the scoring model being obtained by training based on a pre-stored first search information set, a to-be-pushed message set corresponding to a piece of first search information in the first search information set, and a preset priority of a to-be-pushed message in the to-be-pushed message set; and
selecting a preset number of the candidate to-be-pushed messages from the candidate to-be-pushed message set to form a to-be-pushed message sequence in descending order of the probability of being clicked, and pushing the to-be-pushed message sequence to a terminal device of the user.

2. The method according to claim 1, wherein the determining a candidate to-be-pushed message set based on the search information comprises:
determining whether there is target historical search information matching the search information in a pre-stored historical search information list, a piece of historical search information in the historical search information list corresponding to a to-be-pushed message set, and using the to-be-pushed message set corresponding to the target historical search information as the candidate to-be-pushed message set if the target historical search information matching the search information exists.

3. The method according to claim 2, wherein the determining a candidate to-be-pushed message set based on the search information comprises:
sending the search information to a connected database server if the target historical search information does not exist, and retrieving the candidate to-be-pushed message set from the database server.

4. The method according to claim 1, wherein the predicting a probability of being clicked for a candidate to-be-pushed message in the candidate to-be-pushed message set using a pre-trained scoring model based on the search information and the candidate to-be-pushed message set comprises:
extracting a keyword from the search information to generate a first keyword vector;
extracting the keyword from the candidate to-be-pushed message in the candidate to-be-pushed message set to generate a second keyword vector corresponding to the candidate to-be-pushed message; and
introducing, for each of the second keyword vectors, the first keyword vector and the each of the second keyword vectors into the scoring model, to obtain the probability of being clicked for the candidate to-be-pushed message corresponding to the each of the second keyword vectors.

5. The method according to claim 1, wherein before the receiving search information entered by a user, the method further comprises:
executing following model training steps:
obtaining, for each of the pieces of first search information in the first search information set, pairs of the to-be-pushed messages by combining in pairs the to-be-pushed messages in the to-be-pushed message set corresponding to the each of the pieces of first search information, and training a preset machine learning model based on the each of the pieces of first search information, the pairs of the to-be-pushed messages, and the priorities of the to-be-pushed messages in each of the pairs of the to-be-pushed messages, wherein the priorities of the to-be-pushed messages contained in the each of the pairs of the to-be-pushed messages are mutually different;
obtaining a prediction result by executing a prediction on a test sample in a pre-stored test sample set using the trained machine learning model, the test sample in the test sample set containing second search information and a test information pair corresponding to the second search information, and pieces of test information in the test information pair have mutually different preset priorities;
calculating an error rate of the prediction result based on the priorities of the pieces of test information in the test information pair contained in the test sample in the test sample set; and using the trained machine learning model as the scoring model if the error rate is lower than a threshold; and
adjusting the priorities of the to-be-pushed messages in the to-be-pushed message set corresponding to the each of the pieces of first search information in the first search information set based on an error result in the prediction result if the error rate is greater than or equal to the threshold, and continuing to execute the model training steps.

6. The method according to claim 5, wherein at least two of the to-be-pushed messages in the to-be-pushed message set corresponding to the each of the pieces of first search information in the first search information set are sourced from different websites, and for the pieces of test information in the test information pair contained in each of the test samples in the test sample set, at least two of the pieces of test information are sourced from different websites.

7. The method according to claim 6, wherein the adjusting the priorities of the to-be-pushed messages in the to-be-pushed message set corresponding to the each of the pieces of first search information in the first search information set based on an error result in the prediction result comprises:
clustering the pieces of test information corresponding to the error result based on the website of the pieces of test information to obtain a plurality of test information blocks; and
using the website corresponding to the test information block containing a highest number of the pieces of test information among the plurality of test information blocks as a target website, and adjusting the priorities of the to-be-pushed messages sourced from the target website in the to-be-pushed message set corresponding to the each of the pieces of first search information in the first search information set.

8. The method according to claim 5, wherein the training a preset machine learning model based on the each of the pieces of first search information, the pairs of the to-be-pushed messages, and the priorities of the to-be-pushed messages in each of the pairs of the to-be-pushed messages comprises:
acquiring a first word vector corresponding to the each of the pieces of first search information and a second word vector corresponding to each of the to-be-pushed messages contained in the each of the pairs of the to-be-pushed messages respectively, wherein the second word vector is generated based on the keyword contained in the each of the to-be-pushed messages, and the first word vector is generated based on the keyword contained in the each of the pieces of first search information; and
introducing, for the each of the pairs of the to-be-pushed messages, the first word vector and the second word vector corresponding to the each of the to-be-pushed messages in the each of the pairs of the to-be-pushed messages respectively into the machine learning model to obtain the probability of being clicked for the each of the to-be-pushed messages in the each of the pairs of the to-be-pushed messages, and adjusting the machine learning model based on a difference between the priority and the probability of being clicked for the each of the to-be-pushed messages in the each of the pairs of the to-be-pushed messages.

9. A search apparatus based on artificial intelligence, comprising:
at least one processor; and
a memory storing instructions, the instructions when executed by the at least one processor, cause the at least one processor to perform operations, the operations comprising:
receiving search information entered by a user;
determining a candidate to-be-pushed message set based on the search information;
predicting a probability of being clicked for a candidate to-be-pushed message in the candidate to-be-pushed message set using a pre-trained scoring model based on the search information and the candidate to-be-pushed message set, the scoring model being obtained by training based on a pre-stored first search information set, a to-be-pushed message set corresponding to a piece of first search information in the first search information set, and a preset priority of a to-be-pushed message in the to-be-pushed message set; and
selecting a preset number of the candidate to-be-pushed messages from the candidate to-be-pushed message set to form a to-be-pushed message sequence in descending order of the probability of being clicked, and pushing the to-be-pushed message sequence to a terminal device of the user.

10. The apparatus according to claim 9, wherein the determining a candidate to-be-pushed message set based on the search information comprises:
determining whether there is target historical search information matching the search information in a pre-stored historical search information list, a piece of historical search information in the historical search information list corresponding to a to-be-pushed message set, and using the to-be-pushed message set corresponding to the target historical search information as the candidate to-be-pushed message set if the target historical search information matching the search information exists.

11. The apparatus according to claim 10, wherein the determining a candidate to-be-pushed message set based on the search information comprises:
sending the search information to a connected database server if the target historical search information does not exist, and retrieving the candidate to-be-pushed message set from the database server.

12. The apparatus according to claim 9, wherein the predicting a probability of being clicked for a candidate to-be-pushed message in the candidate to-be-pushed message set using a pre-trained scoring model based on the search information and the candidate to-be-pushed message set comprises:
extracting a keyword from the search information to generate a first keyword vector;
extracting the keyword from the candidate to-be-pushed message in the candidate to-be-pushed message set to generate a second keyword vector corresponding to the candidate to-be-pushed message; and
introducing, for each of the second keyword vectors, the first keyword vector and the each of the second keyword vectors into the scoring model, to obtain the probability of being clicked for the candidate to-be-pushed message corresponding to the each of the second keyword vectors.

13. The apparatus according to claim 9, wherein before the receiving search information entered by a user, the operations further comprise:
executing following model training steps:
obtaining, for each of the pieces of first search information in the first search information set, pairs of the to-be-pushed messages by combining in pairs the to-be-pushed messages in the to-be-pushed message set corresponding to the each of the pieces of first search information, and training a preset machine learning model based on the each of the pieces of first search information, the pairs of the to-be-pushed messages, and the priorities of the to-be-pushed messages in each of the pairs of the to-be-pushed messages, wherein the priorities of the to-be-pushed messages contained in the each of the pairs of the to-be-pushed messages are mutually different;
obtaining a prediction result by executing a prediction on a test sample in a pre-stored test sample set using the trained machine learning model, the test sample in the test sample set containing second search information and a test information pair corresponding to the second search information, and pieces of test information in the test information pair have mutually different preset priorities;
calculating an error rate of the prediction result based on the priorities of the pieces of test information in the test information pair contained in the test sample in the test sample set; and using the trained machine learning model as the scoring model if the error rate is lower than a threshold; and
adjusting the priorities of the to-be-pushed messages in the to-be-pushed message set corresponding to the each of the pieces of first search information in the first search information set based on an error result in the prediction result if the error rate is greater than or equal to the threshold, and continuing to execute the model training steps.

14. The apparatus according to claim 13, wherein at least two of the to-be-pushed messages in the to-be-pushed message set corresponding to the each of the pieces of first search information in the first search information set are sourced from different websites, and for the pieces of test information in the test information pair contained in each of the test samples in the test sample set, at least two of the pieces of test information are sourced from different websites.

15. The apparatus according to claim 14, wherein the adjusting the priorities of the to-be-pushed messages in the to-be-pushed message set corresponding to the each of the pieces of first search information in the first search information set based on an error result in the prediction result comprises:
clustering the pieces of test information corresponding to the error result based on the website of the pieces of test information to obtain a plurality of test information blocks; and
using the website corresponding to the test information block containing a highest number of the pieces of test information among the plurality of test information blocks as a target website, and adjusting the priorities of the to-be-pushed messages sourced from the target website in the to-be-pushed message set corresponding to the each of the pieces of first search information in the first search information set.

16. The apparatus according to claim 14, wherein the training a preset machine learning model based on the each of the pieces of first search information, the pairs of the to-be-pushed messages, and the priorities of the to-be-pushed messages in each of the pairs of the to-be-pushed messages comprises:
acquiring a first word vector corresponding to the each of the pieces of first search information and a second word vector corresponding to each of the to-be-pushed messages contained in the each of the pairs of the to-be-pushed messages respectively, wherein the second word vector is generated based on the keyword contained in the each of the to-be-pushed messages, and the first word vector is generated based on the keyword contained in the each of the pieces of first search information; and
introducing, for the each of the pairs of the to-be-pushed messages, the first word vector and the second word vector corresponding to the each of the to-be-pushed messages in the each of the pairs of the to-be-pushed messages respectively into the machine learning model to obtain the probability of being clicked for the each of the to-be-pushed messages in the each of the pairs of the to-be-pushed messages, and adjusting the machine learning model based on a difference between the priority and the probability of being clicked for the each of the to-be-pushed messages in the each of the pairs of the to-be-pushed messages.

17. A non-transitory computer-readable storage medium storing a computer program, the computer program when executed by one or more processors, causes the one or more processors to perform operations, the operations comprising:
receiving search information entered by a user;
determining a candidate to-be-pushed message set based on the search information;
predicting a probability of being clicked for a candidate to-be-pushed message in the candidate to-be-pushed message set using a pre-trained scoring model based on the search information and the candidate to-be-pushed message set, the scoring model being obtained by training based on a pre-stored first search information set, a to-be-pushed message set corresponding to a piece of first search information in the first search information set, and a preset priority of a to-be-pushed message in the to-be-pushed message set; and
selecting a preset number of the candidate to-be-pushed messages from the candidate to-be-pushed message set to form a to-be-pushed message sequence in descending order of the probability of being clicked, and pushing the to-be-pushed message sequence to a terminal device of the user.
